(19) United States
(12) Patent Application Publication
(10) Pub. No.: US 2003/0235172 A1
(43) Pub. Date: Dec. 25, 2003

(54) Asset tracking methods and apparatus

(75) Inventor: Stephen R. Wood, Beaverton, OR (US)

Correspondence Address: SCHWEGMAN, LUNDBERG, WOESSNER & KLUTH, P.A., P.O. BOX 2938, MINNEAPOLIS, MN, 55402, US

(73) Assignee: Intel Corporation

(21) Appl. No.: 10/178,879

(22) Filed: Jun. 24, 2002

(51) Int. Cl. G06F 9/45

(52) U.S. Cl. 370/338; 370/334

(57) ABSTRACT

A network may determine the location of network nodes and asset tags, and the network nodes may provide direction information that point to asset tags.

### BACKGROUND

Asset tracking systems exist to track the location of assets. For example, in a hospital, the location of medical equipment may be tracked using an asset tracking system. Also for example, in a retail shop, the location of goods for sale may be tracked using an asset tracking system.

Some asset tracking systems are “perimeter systems” that track assets by detecting whether any assets have crossed a boundary or perimeter. Perimeter systems are common in retail environments. Other asset tracking systems are “location-based systems” that track the location of assets more closely than perimeter systems. For example, location-based asset tracking systems are common in hospitals and in other environments where it is convenient to know the location of an asset with a greater degree of precision than is offered by perimeter systems.

For the reasons stated above, and for other reasons stated below which will become apparent to those skilled in the art upon reading and understanding the present specification, there is a need in the art for improved location-based asset tracking systems.

### BRIEF DESCRIPTION OF THE DRAWINGS

FIG. 1 shows a diagram of a wireless network;

FIG. 2 shows a diagram of a network access point device;

FIG. 3 shows a diagram of a network server;

FIG. 4 shows a diagram of a mobile network node;

FIG. 5 shows a diagram of another mobile network node;

FIG. 6 shows a perspective view of a tactile display;

FIG. 7 shows a top view of a visual display;

FIG. 8 shows a diagram of an asset tag; and

FIGS. 9 and 10 show flowcharts in accordance with various embodiments of the present invention.

### DESCRIPTION OF EMBODIMENTS

In the following detailed description of the embodiments, reference is made to the accompanying drawings which show, by way of illustration, specific embodiments in which the invention may be practiced. In the drawings, like numerals describe substantially similar components throughout the several views. These embodiments are described in sufficient detail to enable those skilled in the art to practice the invention. Other embodiments maybe utilized and structural, logical, and electrical changes may be made without departing from the scope of the present invention. Moreover, it is to be understood that the various embodiments of the invention, although different, are not necessarily mutually exclusive. For example, a particular feature, structure, or characteristic described in one embodiment may be included within other embodiments. The following detailed description is, therefore, not to be taken in a limiting sense, and the scope of the present invention is defined only by the appended claims, along with the full scope of equivalents to which such claims are entitled.

In various embodiments of the present invention as described in more detail below, assets that are “tracked” have an asset tag affixed thereto, and a network that includes many components may track the location of the asset. The network may also track the location and orientation of wireless network nodes and provide the network nodes with information to display a direction to a tracked asset. A user in possession of the mobile network node may then be able to find the tracked asset.

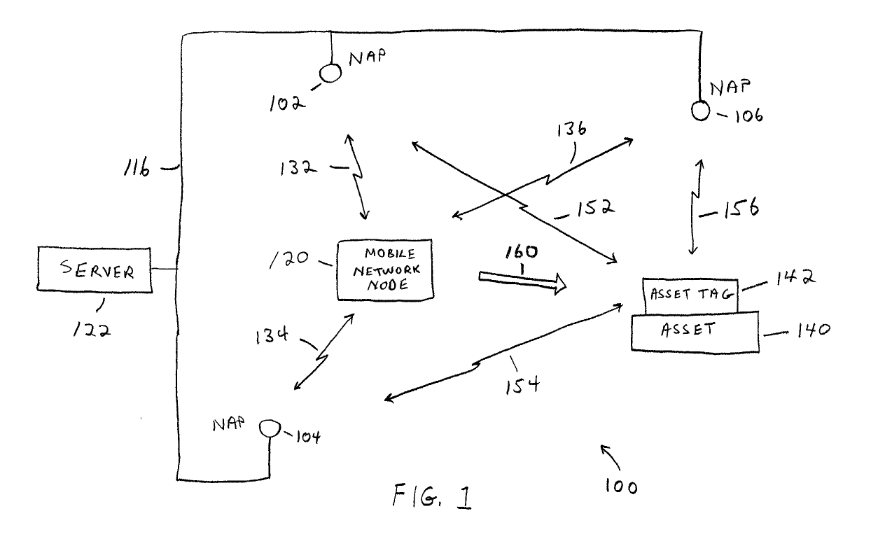

FIG. 1 shows a diagram of a wireless network. Network 100 includes server 122, network access points (NAPs) 102, 104, and 106, mobile network node 120, asset 140, and asset tag 142. Access points 102, 104, and 106 are coupled to server 122 by media 116, and one or more of access points 102, 104, and 106 are coupled to node 120 by wireless links 132, 134, and 136. The combination of access points 102, 104, and 106, and server 122 provide network services to mobile network node 120 and asset tag 142. In addition, node 120 may, in some embodiments, provide network services to other nodes (not shown), or to any of access points 102, 104, and 106.

Wireless network 100 may be any type of network that allows a node to access network services using a wireless link. For example, in some embodiments of the present invention, wireless network 100 represents a cellular telephone network, and in other embodiments, wireless network 100 represents a wireless local area network (WLAN) or wireless wide area network (WWAN). In still further embodiments, network 100 is a hybrid system that provides a combination of different services to network nodes and access points. For example, in some embodiments, wireless network 100 provides asset tracking services to mobile network nodes. Media 116 may be any type of signal transmission media capable of providing a data communication path between server 122 and access points 102, 104, and 106. Examples include, but are not limited to: wires, fiber optic cables, and wireless links.

Asset tag 142 is an item that can be physically affixed to an asset that is tracked. For example, in the embodiments represented by FIG. 1, asset tag 142 is affixed to asset 140. As described below, the location of asset tag 142 may be tracked by network 100, and the location of tracked assets may be communicated to network nodes such as mobile network node 120.

Mobile network node 120 may be any type of network node capable of accessing network services using a wireless link. For example, node 120 may be a cellular telephone, a computer, a personal digital assistant (PDA), or any other type of device that can access a network using a wireless link. In some embodiments, node 120 may be a combination cellular phone and computer that provides both wireless data and voice services. In other embodiments, node 120 may be a device that displays asset tracking information to a user having access to node 120.

In general, nodes and access points are network elements that may provide network services, receive network services, or both. For example, in cellular network embodiments, access points 102, 104, and 106 may be cellular base stations that provide network services and node 120 may be a cellular telephone that primarily receives network services. Also for example, in wireless LAN embodiments, access points 102, 104, and 106, and node 120 may be computers that provide and receive network services. The remainder of this description describes many different embodiments of the present invention, with an emphasis on wireless LAN embodiments useful for asset tracking. The emphasis on wireless LAN embodiments is provided for clarity, and one of ordinary skill in the art will understand that the present invention is not to limited wireless LANs.

In operation, network 100 provides the ability to determine the location of mobile network nodes and asset tags. Throughout this description, this ability is referred to as “location determination.” Network 100 provides location determination of node 120 through the use of wireless links 132, 134, and 136. Network 100 also provides location determination of asset tag 142 through the use of wireless links 152, 154, and 156. Networks that provide location determination are referred to herein as “location-aware networks.” Network 100 is a location-aware network that provides location determination of node 120 and asset tag 142 through the use of the various wireless links.

Wireless links 132, 134, and 136 provide communication paths between node 120 and access points 102, 104, and 106. Wireless links 152, 154, and 156 provide communication paths between asset tag 142 and access points 102, 104, and 106. The various access points send and receive wireless signals to and from node 120 and asset tag 142 on the wireless links, and also send and receive signals to and from server 122 using media 116. In some embodiments, network node 120 communicates with the network using only one of the wireless links shown, but multiple network access points receive the signals transmitted by network node 120.

In some embodiments, the wireless links utilize a pulse-based radio frequency (RF) protocol to provide communications between node 120 and access points 102, 104, and 106. In these embodiments, short RF pulses are transmitted by node 120 and asset tag 142, and these short RF pulses are received by access points 102, 104, and 106. In other embodiments, the wireless links utilize baseband modulated protocols in which the desired data to be transmitted is superimposed by various means on a sinusoidal carrier signal. One example of a suitable pulse-based protocol is the emerging ultra-wideband (UWB) protocol in which low power, short duration, pulses are transmitted over the wireless link. Another example of a suitable pulse-based protocol is described in U.S. Pat. No. 6,031,862, issued to Fullerton et al., on Feb. 29, 2000. In other embodiments, wireless links 132, 134, 136, 152, 254, and 156 utilize a data modulated sinusoidal carrier. Any type of wireless protocol can be utilized for the wireless links.

Information received from wireless network node 120 may include any information contained within the signals received from node 120. For example, the signals may contain voice information or data information, in any analog or digital format suitable for requesting or providing network services. Information received from asset tag 142 may also include any type of information. For example, an asset tag may send information representing a serial number, an asset description, or any other information of use to network 100.

When receiving wireless signals from node 120 and asset tag 142, the various access points may also gather information describing attributes of the wireless signals. For example, in pulse-based embodiments, the access points may gather pulse time-of-arrival, information as well as angle-of-arrival, pulse amplitude, pulse duration, and rise/fall time information. In sinusoidal carrier embodiments, the access points may gather center frequency, amplitude, angle-of-arrival, phase offset, or other information. In general, information gathered describing attributes of the received signals may include any information suitable to support location determination or asset tracking. For example, pulse time-of-arrival information or angle-of-arrival information, or both, may be used to determine the location of network node 120 relative to the locations of the access points. Also for example, phase offset of a received sinusoidal carrier signal may also be used in support of location determination.

Attributes of received wireless signals may be transmitted from the various access points to server 122. These attributes may then be used by server 122 to determine the locations of node 120 and asset tag 142. For example, in pulse-based embodiments, pulse time-of-arrival and optionally pulse angle-of-arrival information gathered by the access points may be used to resolve the locations of node 120 and asset tag 142 relative to the locations of the access points that measure the time-of-arrival and/or angle-of-arrival. Also for example, in sinusoidal carrier embodiments, phase offsets may be used to resolve the locations of node 120 and asset tag 142.

In addition to location determination, network 100 may provide the ability to determine the orientation of a mobile network node. For example, network 100 may determine the orientation of mobile network node 120 in two or three dimensions. Mobile network node 120 may then display information describing the direction to a tracked asset that is associated with an asset tag. As shown in FIG. 1, the direction from mobile network node 120 to asset 140 is shown by arrow 160.

FIG. 1 shows three access points. In embodiments with three access points capable of receiving signals from node 120 and asset tag 142, the location and orientation of node 120 and asset tag 142 can be determined in two dimensions. Some embodiments have more than three access points. In embodiments with four or more access points capable of receiving signals from node 120 and asset tag 142, the location and orientation may be determined in three dimensions. In some embodiments, information about the environment may be combined with information from access points to determine the location of node 120. For example, information describing the placement of walls, ceilings, or obstructions may be combined with information from two network access points to determine the location of node 120 in two dimensions.

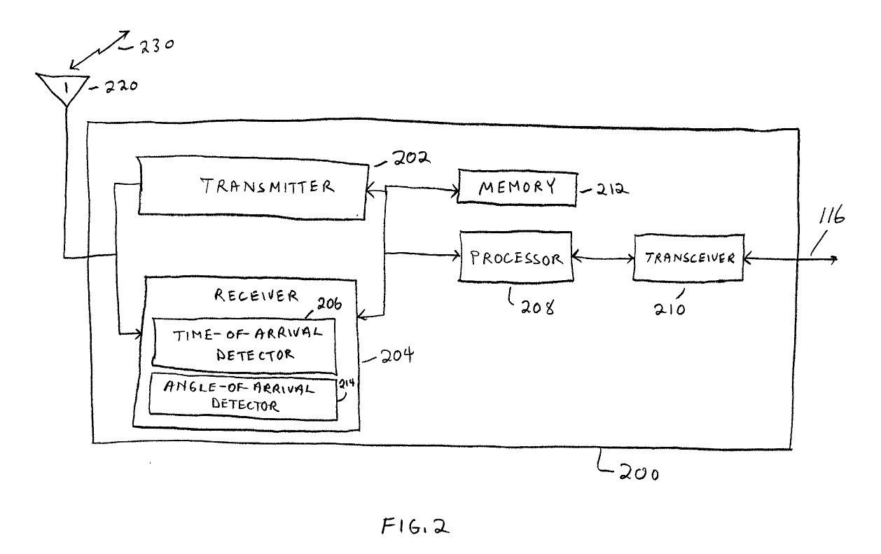

FIG. 2 shows a diagram of a network access point device suitable for use at the network access points shown in FIG. 1. Network access point device 200 includes transmitter 202, receiver 204, time-of-arrival detector 206, angle-of-arrival detector 214, processor 208, and transceiver 210. Transceiver 210 communicates with a server (not shown) using media 116. Transceiver 210 also communicates with processor 208. Transmitter 202 and receiver 204 both communicate with processor 208 and antenna 220.

Antenna 220 receives wireless signals from network nodes and asset tags on wireless link 230. In some embodiments, wireless signals on wireless link 230 include electromagnetic pulses as described above with reference to FIG. 1. In these embodiments, receiver 204 receives the pulses, and time-of-arrival detector 206 detects the arrival time of the pulse. Time-of-arrival information is one of many possible attributes of a wireless signal that may be measured by receiver 204. For example, in some embodiments, angle-of-arrival detector 214 detects the angle from which the pulse arrived as an attribute of the wireless signal. Some embodiments measure both time-of-arrival and angle-of-arrival. Processor 208 receives information describing the wireless signal from receiver 204 and provides it to a network server using transceiver 210.

Time-of-arrival detector 206 can be implemented in a number of different ways. In one embodiment, the function of the time-of-arrival detector is a separate module within the network access point device 200. In other embodiments, time-of-arrival detector 206 is integrated into receiver 204. In yet other embodiments, time-of-arrival detector 206 utilizes processing capabilities of processor 208 to perform its function.

Angle-of-arrival detector2l4 can also be implemented in a number of different ways. In some embodiments, angle-of-arrival detector 214 is a circuit that receives signals from a phased-array antennal to measure the angle from which the signals are received. In these embodiments, antenna 220 represents a phased-array antenna. Many other mechanisms can be used to measure the angle-of-arrival of the wireless signal.

Processor 208 may be any type of processor suitable to perform actions to support the operation of network access point device 200. For example, processor 208 may be a microprocessor, a microcontroller, or the like. Also for example, processor 208 may be a hardware controller or a collection of hardware controllers that perform specific task. Memory 212 represents an article that includes a machine-accessible medium. For example, memory 212 may represent any one or more of the following: a hard disk, a floppy disk, random access memory (RAM), read only memory (ROM), flash memory, CDROM, or any other type of article that includes a medium readable by a machine. Memory 212 may store instructions for performing the execution of the various method embodiments of the present invention. Memory 212 may also include data describing the current state of network access point device 200 and the entire network.

When multiple network access point devices 200 measure attributes of a single electromagnetic pulse, a network server may utilize this information to resolve the location of the network node from which the pulse originated. In some embodiments, multiple electromagnetic pulses are received by receiver 204. The multiple electromagnetic pulses may represent any type of communication from a network node. For example, a group of pulses may represent a request from a network node to locate a particular asset. Also for example, a group of pulses may represent a different data communication from a network node. Receiver 204 derives information from groups of pulses, as well as from attributes describing the pulses. Processor 208 receives from receiver 204 information describing both groups of pulses as well as attributes of individual pulses. For example, processor 208 may receive data from a network node, as well as receiving time-of-arrival and angle-of-arrival information of pulses received by receiver 204.

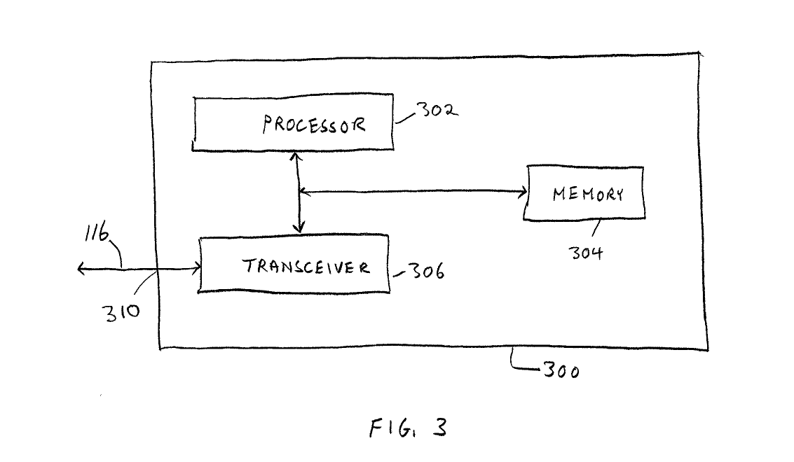

FIG. 3 shows a diagram of a network server suitable for use in a wireless network such as network 100 (FIG. 1). Server 300 includes processor 302, memory 304, and transceiver 306. Transceiver 306 is coupled to media 116 at port 310. As described above with reference to FIG. 1, media 116 couples the network server with any number of network access point devices such as network access point device 200 (FIG. 2). Transceiver 306 receives information from network access point devices on media 116. In some embodiments, wireless signal attributes are received from multiple network access point devices, and processor 302 determines the location of a transmitter from which the wireless signals originated. Server 300 may be a personal computer (PC), server, mainframe, handheld device, portable computer, or any other system that may perform the operations described herein.

Memory 304 represents an article that includes a machine-accessible medium. For example, memory 304 may represent any one or more of the following: a hard disk, a floppy disk, random access memory (RAM), read only memory (ROM), flash memory, CDROM, or any other type of article that includes a medium readable by a machine. Memory 304 may store instructions for performing the execution of the various method embodiments of the present invention. Memory 304 may also include data describing the current state of server 300 and the entire network. For example, memory 304 may include data describing assets, asset serial numbers, locations of assets, as well as the locations of network nodes.

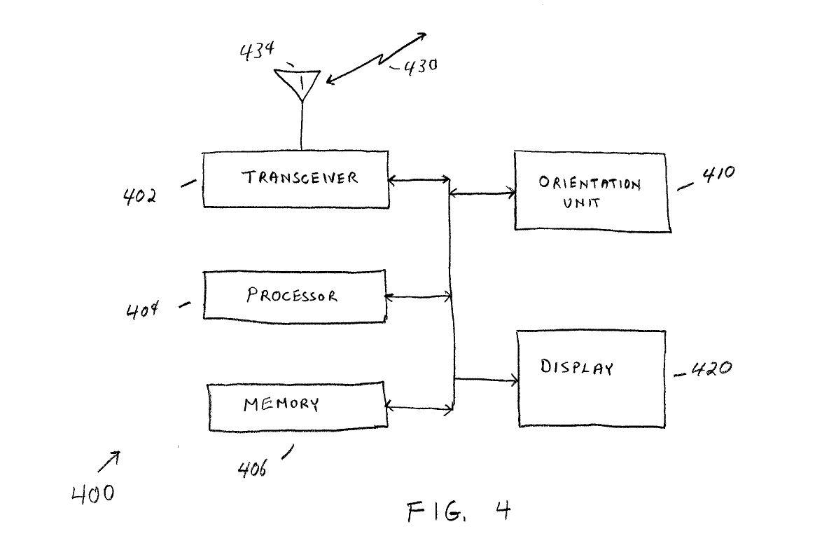

FIG. 4 shows a diagram of a mobile network node. Mobile network node 400 is a mobile network node suitable for use as mobile network node 120 (FIG. 1). Node 400 includes transceiver 402, processor 404, memory 406, orientation unit 410, and display 420. Transceiver 402 includes a transmitter and receiver to communicate with a network on wireless link 430 using antenna 434. As described above, transceiver 402 may communicate with a network using pulse-based wireless signals, modulated sinusoidal wireless signals, or any other suitable wireless signal protocol.

Processor 404 may be any type of processor capable of communicating with other portions of node 400. As described above with reference to FIG. 1, node 400 may be one of many different types of devices, and this also true of processor 404. For example, processor 404 may be a microprocessor, a microcontroller, or the like. Also for example, processor 404 may be a hardware controller or a collection of hardware controllers that perform a specific task.

Memory 406 represents an article that includes a machine-accessible medium. For example, memory 406 may represent any one or more of the following: a hard disk, a floppy disk, random access memory (RAM), read only memory (ROM), flash memory, CDROM, or any other type of article that includes a medium readable by a machine. Memory 406 may store instructions for performing the execution of the various method embodiments of the present invention.

Orientation unit 410 may be a device that allows node 400 to determine its physical orientation. In some embodiments, orientation unit 410 may be a compass, and in other embodiments, orientation unit 410 may be an accelerometer that is periodically reset. In these embodiments, processor 404 may determine the orientation of node 404 by reading a status of orientation unit 410, and then utilize the orientation information when displaying information using display 420.

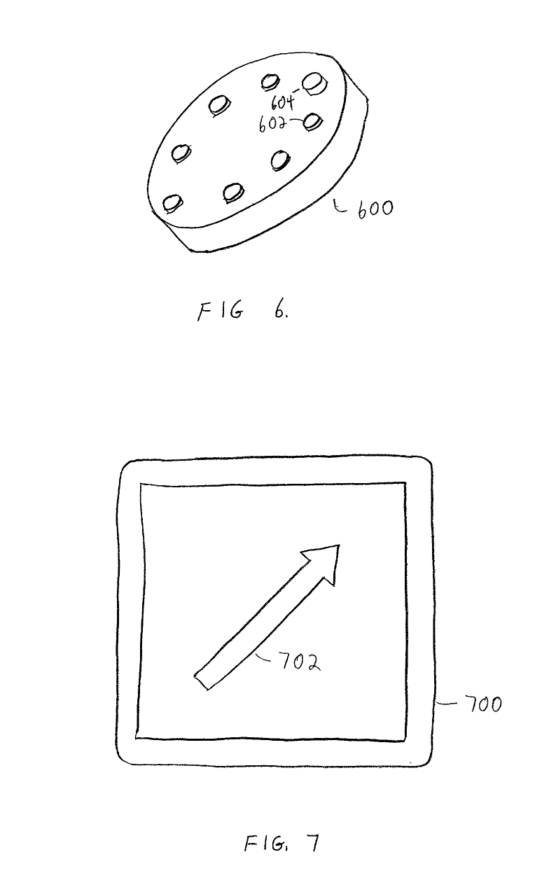

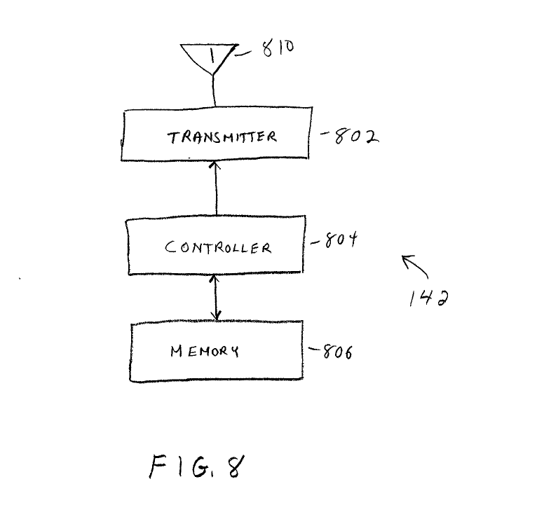

Display 420 may be a display unit that displays information to a user. For example, in some embodiments, display 420 may be a visual display, and in other embodiments, display 420 may be a tactile display. Example visual and tactile displays are shown in FIGS. 6 and 7, and are described below with reference thereto. In some embodiments, display 420 may be used to display a direction to a tracked asset. For example, display 420 may display an arrow that points toward the tracked asset. When the orientation of node 400 is utilized for this purpose, the arrow that is displayed may be made to point toward the tracked asset regardless of the orientation of node 400.

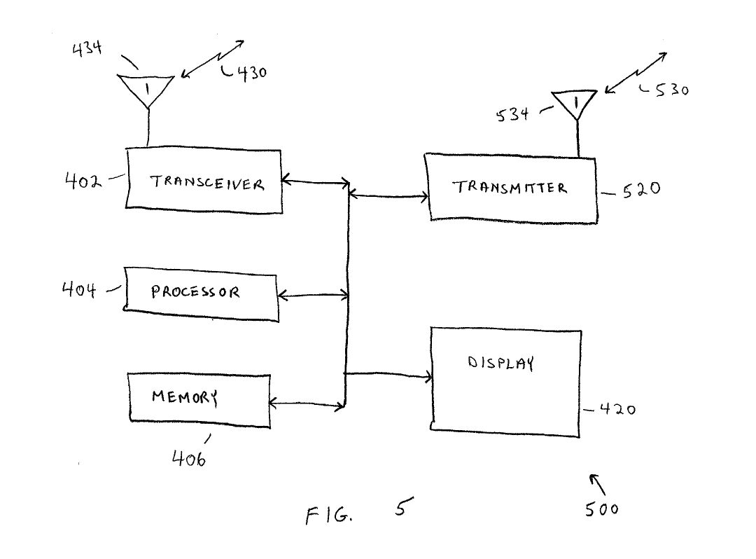

FIG. 5 shows a diagram of another mobile network node. Mobile network node 500 represents an embodiment of mobile network node 400 (FIG. 4) in which orientation unit 410 is implemented as transmitter 520 and antenna 534. In some embodiments represented by FIG. 5, the mobile network node includes multiple transmitters (402, 520) and multiple antennas (434, 534). In other embodiments, transmitter 520 is omitted, and antenna 534 is coupled to transmitter 402.

Antennas 434 and 534 are physically spaced apart, or “spatially diverse,” on mobile network node 500 such that a wireless network may separately determine the locations of the two antennas. For example, signals on wireless links 430 and 530 may be received by multiple network access points, such as those shown in FIG. 1, and the locations of antennas 434 and 534 may be determined separately. In these embodiments, the network determines the orientation of mobile network node 500 by determining the location of multiple, spatially diverse, antennas. The network may transmit information describing the orientation to the mobile network node. For example, signals on wireless link 430 may include orientation information transmitted to mobile network node 500 by the network.

FIG. 6 shows a perspective view of a tactile display. Tactile display 600 may be a display device that can be held by a user to provide tactile information regarding the direction to a tracked asset. Shown on tactile display 600 are a number of indicating elements including indicating elements 602 and 604. Indicating element 604 is raised to indicate the direction to a tracked asset. The user holding display 600 may receive tactile feedback from indicating element 604 to direct the user toward the tracked asset.

Display 600 is a tactile display that is part of a mobile network node such as mobile network node 400 (FIG. 4) or mobile network node 500 (FIG. 5). As such, tactile display 600 may be used to display the direction to a tracked asset. As display 600 is rotated, a different indicating element may be raised to indicate the direction to the tracked asset. Because the orientation of the mobile network node is known, display 600 may properly indicate the direction to a tracked asset regardless of its orientation.

FIG. 7 shows a top view of a visual display. Display 700 is an example of a visual display that can display the direction to a tracked asset in either two or three dimensions. Included on display 700 is arrow 702. As display 700 is rotated, arrow 702 rotates such that it continues to point in the direction of the tracked asset. In some embodiments, display 700 includes a grid or shape representing the environment in which display 700 operates. For example, in a warehouse environment, a series of aisles may appear on the display to help visually orient the user.

Display 700 may be a display device dedicated to the use of tracking assets, or may be a display device that is part of network node that is not dedicated to tracking assets. For example, in some embodiments, the mobile network node is a personal digital assistant (PDA), and display 700 is a display device used for many purposes such as reading e-mail, and navigating the Internet.

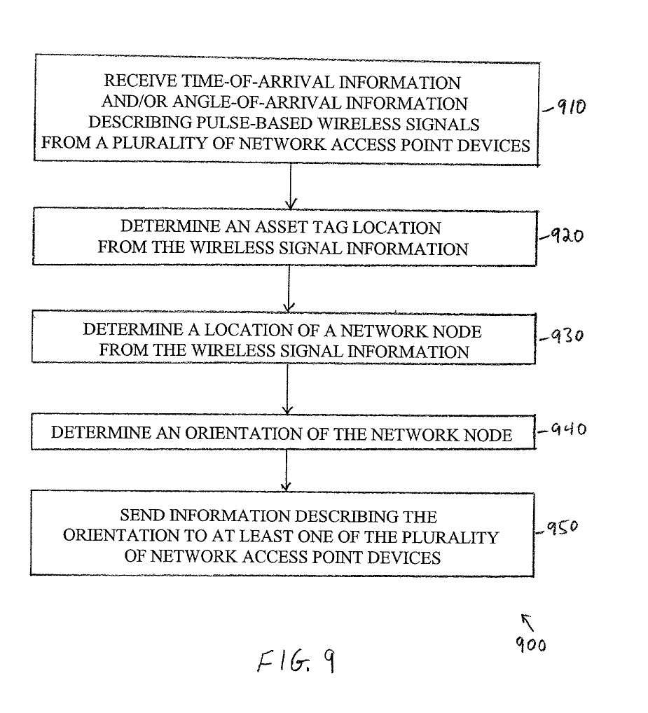

FIG. 8 shows a diagram of an asset tag. Asset tag 142 is an asset tag suitable for use in a mobile network such as network 100 (FIG. 1). Asset tag 142 includes transmitter 802, controller 804, and memory 806. Transmitter 802 is a transmitter capable of transmitting wireless signals using antenna 810. Referring now back to FIG. 1, asset tag 142 sends wireless signals to network access points, and the network determines the location of the asset tag. As shown in FIG. 1, asset tag 142 sends and receives wireless signals 152, 154, and 156.

Referring now back to FIG. 8, controller 804 may be any type of controller, and memory 806 may be any kind of memory. For example, controller 804 may be a microprocessor, a microcontroller, or the like. Also for example, controller 804 may be a hardware controller or a collection of hardware controllers that perform a specific task. Memory 806 represents an article that includes a machine-accessible medium. For example, memory 806 may represent any one or more of the following: a hard disk, a floppy disk, random access memory (RAM), read only memory (ROM), flash memory, CDROM, or any other type of article that includes a medium readable by a machine. Memory 806 may store instructions for performing the execution of the various method embodiments of the present invention. Memory 806 may also include information related to an asset such as a serial number or an asset description. In some embodiments, memory 806 may be a dedicated write-only memory that is inexpensively produced.

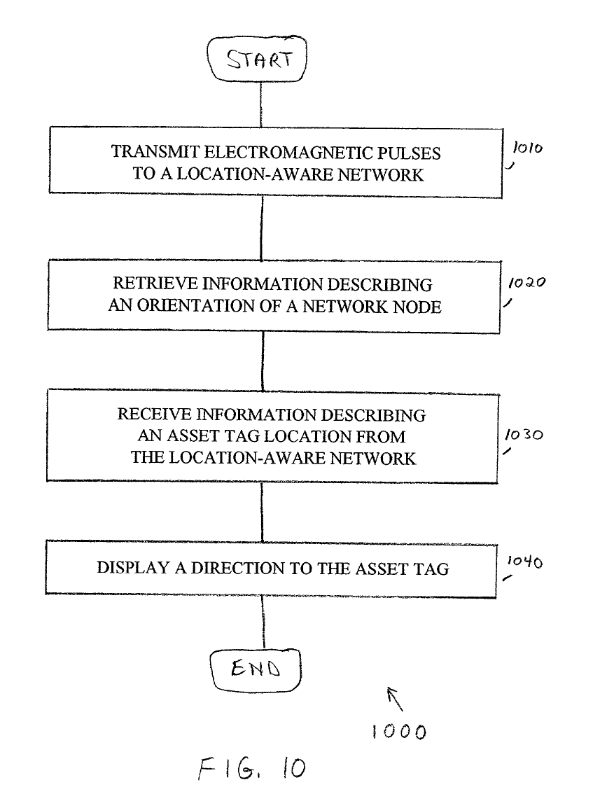

FIGS. 9 and 10 show flowcharts in accordance with various embodiments of the present invention. The flowcharts shown in FIGS. 9 and 10 illustrate various method embodiments that may be performed in an asset tracking network. In some embodiments, the methods may be performed by a server such as server 300 (FIG. 3) or by a mobile network node such as mobile network node 120 (FIG. 1). In other embodiments, the methods may be distributed across a server and network access point devices. The various actions shown in the figures may be performed in the order presented, or may be performed in a different order. Further, in some embodiments, some actions listed in the figures are omitted.

Referring now to FIG. 9, method 900 begins at 910 when information describing pulse-based wireless signals is received from a plurality of network access points devices. In some embodiments, this information includes time-of-arrival and/or angle-of-arrival information that describes the arrival time or arrival angle of pulses in the wireless signals. In some embodiments, block 910 corresponds to server 122 (FIG. 1) receiving information from the various network access points shown in FIG. 1. The wireless signal information referred to in block 910 may correspond to wireless signals transmitted from mobile network nodes and asset tags, such as mobile network node 120 and asset tag 142. Further, the wireless signal information may include information describing multiple wireless signals received from a single mobile network node, such as mobile network node 500 (FIG. 5).

As shown in block 920, an asset tag location is determined from the wireless signal information. This may be performed by resolving the location of the asset tag based on the information received from a plurality of network access point devices. The asset tag location may be resolved by triangulation. As shown in block 930, the location of a network node is determined from the wireless signal information. This may be performed by triangulating the location of the mobile network node based on the information received from the plurality of network access points devices.

As shown in block 940, the orientation of the network node is determined. This may be performed using many different possible mechanisms. For example, in some embodiments, the mobile network node transmits multiple signals from spatially diverse antennas. The antennas are spaced far enough apart such that the location of each can be determined separately, and the orientation of the network node may be determined therefrom. In other embodiments, the mobile network node includes an orientation unit that allows the mobile network node to determine its own orientation. Examples of such embodiments are described above with reference to FIG. 4. As shown in block 950, information describing the orientation of the network node is sent to at least one of the plurality of network access point devices. This allows a network access point device to transmit the orientation information to a mobile network node, thereby allowing the mobile network node to determine the direction to a tracked asset and to display that direction correctly irrespective of the orientation of the mobile network node.

FIG. 10 shows a flowchart of a method for operating a mobile network node in a location-aware network. Method 1000 begins in Block 1010 when electromagnetic pulses are transmitted to a location-aware network. This corresponds to a mobile network node communicating with the network, such as mobile network node 120 transmitting signals to network access points (FIG. 1). In block 1020, information describing an orientation of the mobile network node is retrieved. In some embodiments, this corresponds to reading a compass, and in other embodiments this corresponds to reading the status of an internally maintained accelerometer. In still further embodiments, this corresponds to receiving information from the location-aware network describing the orientation of the network node.

In block 1030, information is received describing an asset tag location, and in block 1040 a direction to the asset tag is displayed. This corresponds to a mobile network node displaying tactile or visual data to aid a user in locating an asset.

It is to be understood that the above description is intended to be illustrative, and not restrictive. Many other embodiments will be apparent to those of skill in the art upon reading and understanding the above description. The scope of the invention should, therefore, be determined with reference to the appended claims, along with the full scope of equivalents to which such claims are entitled.

What is claimed is:

1. A device comprising:
a transmitter to transmit wireless signals to at least one network access point;
a receiver to receive signals having direction information therein; and
a display device to display the direction information.

2. The device of claim 1 further comprising an orientation unit to determine an orientation of the device.

3. The device of claim 2 wherein the orientation unit comprises an accelerometer.

4. The device of claim 2 wherein the orientation unit comprises a compass.

5. The device of claim 2 wherein the orientation unit comprises a plurality of antennas to transmit wireless signals to the at least one network access point.

6. The device of claim 1 wherein the display device comprises a plurality of tactile indicators.

7. The device of claim 6 wherein the plurality of tactile indicators comprises a plurality of indicating elements configured to raise from the device to indicate direction.

8. The device of claim 1 wherein the display device comprises a visual display.

9. The device of claim 8 wherein the visual display is configured to show the direction information irrespective of an orientation of the device.

10. The device of claim 1 further comprising:
a first antenna coupled to the transmitter; and
a second antenna coupled to the transmitter, the second antenna being spaced apart from the first antenna;
wherein the transmitter is configured to transmit pulse-based wireless signals.

11. A network comprising:
a plurality of network access point devices, each of the plurality of network access point devices including a receiver to receive wireless signals from a network node and an asset tag, and including a transmitter to transmit attributes of the wireless signals; and
a server coupled to the plurality of network access point devices to receive the attributes of the wireless signals, to determine a network node location, an asset tag location, and a direction from the network node to the asset tag, and to provide the network node with information describing the direction.

12. The network of claim 11 wherein the server is configured to determine the orientation of the network node.

13. The network of claim 12 further comprising the network node, the network node including two antennas to allow the server to determine an orientation of the network node.

14. The network of claim 12 wherein each of the plurality of network access point devices is configured to receive pulsed wireless signals from the network node and from the asset tag.

15. The network of claim 14 wherein each of the plurality of network access point devices further includes time-of-arrival detection circuitry to detect time-of-arrival of pulses as one of the attributes of the wireless signals.

16. The network of claim 15 wherein the server is configured to receive the time-of-arrival from each of the plurality of network access point devices and resolve the network node location and the asset tag location.

17. A network server comprising at least one port to couple the network server to a plurality of wireless network access point devices, the network server being configured to receive wireless signal attributes from the plurality of wireless network access point devices, to determine a location and orientation of a transmitter from the wireless signal attributes, and to send information describing the orientation of the transmitter to at least one of the plurality of network access point devices.

18. The network server of claim 17 wherein the network server is further configured to receive time-of-arrival information from the wireless network access point devices.

19. The network server of claim 18 wherein the network server is further configured to resolve the location of the transmitter using the time-of-arrival information.

20. The network server of claim 19 wherein the network server is configured to receive additional time-of-arrival information describing electromagnetic pulses received from an asset tag, and configured to determine a location of the asset tag.

21. A method comprising:
receiving wireless signal information from a plurality of network access point devices;
determining an asset tag location from the wireless signal information;
determining a location of a network node from the wireless signal information;
determining an orientation of the network node; and
sending information describing the orientation to at least one of the plurality of network access point devices.

22. The method of claim 21 wherein receiving wireless signal information comprises receiving time-of-arrival information describing pulse-based wireless signals.

23. The method of claim 21 wherein determining an orientation of the network node comprises resolving two locations corresponding to two signals transmitted from the network node.

24. An article comprising a machine-accessible media having associated data, wherein the data, when accessed, results in a machine performing:
transmitting electromagnetic pulses to a location-aware network;
retrieving information describing an orientation of the machine;
receiving information describing an asset tag location from the location-aware network; and
displaying a direction to the asset tag.

25. The article of claim 24 wherein retrieving information describing an orientation of the machine comprises reading a compass.

26. The article of claim 24 wherein retrieving information describing an orientation of the machine comprises reading an accelerometer.

27. The article of claim 24 wherein transmitting a plurality of electromagnetic pulses comprises transmitting pulses from a plurality of antennas.

28. The article of claim 27 wherein retrieving information describing an orientation of the machine comprises receiving orientation information from the location-aware network.

29. The article of claim 24 wherein displaying a direction to the asset tag comprises providing tactile direction information.

30. The article of claim 24 wherein displaying a direction to the asset tag comprises displaying visual direction information on a display device.
